(19) United States
(12) Patent Application Publication
(10) Pub. No.: US 2012/0201094 A1
(43) Pub. Date: Aug. 9, 2012

(54) DISPERSION APPARATUS FOR ROTATING DRUM

(75) Inventors: Amlan Datta, Mumbai (IN); Parag Malode, Mumbai (IN)

(73) Assignee: Aditya Birla Science & Technology Co., Ltd., Maharashtra (IN)

(21) Appl. No.: 13/501,421

(22) PCT Filed: Mar. 15, 2011
(86) PCT No.: PCT/IN11/00174

§ 371 Date: Apr. 11, 2012

(30) Foreign Application Priority Data
Mar. 18, 2010 (IN) 717/MUM/2010

(51) Int. Cl. B01F 9/02

(52) U.S. Cl. 366/226

(57) ABSTRACT

A dispersion apparatus for agitating particulate mass in a rotating drum. The dispersion apparatus comprises a plurality of perforated flights radically extending from the inner surface of the rotating drum which rotates about an operatively longitudinal axis. The perforated flights are provided with at least one perforation. The perforated flights have the advantage of increasing the throughput of the rotating drum unit, reducing the time required for heating and mass transfer by increasing the contact surface of the perforated flights with the particulate mass to be dispersed by the dispersion apparatus.

### CROSS-REFERENCE TO RELATED APPLICATIONS

This application is a National Stage application of International Application No. PCT/IN2011/000174, filed on Mar. 15, 2011, which claims priority of Indian patent application number 717/MUM/2010, filed on Mar. 18, 2010, both of which are incorporated herein by reference in their entireties.

### BACKGROUND OF THE INVENTION

1. Field of the Invention

The present invention relates to bulk material handling/processing equipment.

In particular the present invention relates to flights for rotary a drum.

2. Description of the Prior Art

Bulk solids handling is quite prevalent in industries processing food grains, cement, specialty chemicals, minerals, pharmaceuticals and the like. Majority of the bulk solid handling is carried out by employing rotary drums to process large quantities of material and operate in a simple and cost-effective manner. The rotary drums are always used to achieve mass transfer or heat transfer, and in many cases to achieve both.

The drums are generally horizontal or slightly inclined to the horizontal for continuous or batch processing of material. In a majority of such processes, the drum rotates slowly about its axis at speeds ranging from 0 to 10 RPM, which is set as per the requirement. In such rotating drums, the bulk particulate material also rotates at a slow speed, thus, forming a bed of particulate material at the drum bottom. The bed of particulate material keeps on rolling across the cross-section of the drum.

In order to enable better agitation and mixing of the bulk solids, such rotary devices often have internal fixtures or protrusions along the inner wall surface termed as flights or lifters. During rotation, the flights help in disturbing the bed of particulate material and aggravate mixing of the particulate material. These flights are discrete, and often equally spaced along the inner wall surface and are fixed in a particular combination or arrangement along the drum length. In most cases, all flights are identical and spaced equidistant along the circumference. The number of flights and arrangement of the flights to be used depends on certain requirements such as the capacity of the drum, the heat duty of the drum and the nature of the particulate mass.

The rotary drums are generally loaded up to 15% and the entire drum volume, during rotation, is used to pick up only a part of the particulate material with the flights and then throw back the particulate material into the bed. The continuous motion of the particulate material and its interaction with a gas, typically air, results in heat and mass transfer. The efficacy of such heat and mass transfer process using the rotary drum with the flights depends on the following parameters:
Properties of the particulate material and the gas;
Quantity of the particulate material in contact with the surrounding gas at any instant;
Quantity of gas, at a temperature different than the particulate material, available in the surroundings and that which interacts with the available particulate material; and
Absolute temperature of the particulate material and the gas during the interaction.

Theoretically, there are namely, equal angular distribution flights (EAD) and centrally biased distribution flights (CBD). EAD flights have an equal distribution of particles across the horizontal diameter of the rotary drum whereas CBD flights have a greater proportion of particles cascaded at and around the vertical diameter of the drum. However, these are theoretical designs and have not been applied in practice industrially because of the seemingly complex geometries and intricate designs that are difficult to produce in a cost effective manner

Several attempts have been made for manufacture flights for increasing the heat and mass transfer.

U.S. Pat. No. 3,576,080 discloses a rotary cooler that is provided with a cylindrical shell with parts assembled in groups to divide the interior of the shell into cells. Each of the cell defining assemblies include a pair of arcuately spaced apart wall structures and each wall structure has a radially inward projecting and longitudinally extending surface forming a scoop which in end view is a J-shape having a back portion, a bottom portion and a lip portion defining a pocket there between.

U.S. Pat. No. 3,780,447 discloses a rotary dryer with flights at the feed end and a dam assembly with movable ring segment and a flight position. The ring segment moves in the direction of material flow.

U.S. Pat. No. 4,131,418 discloses a tube cooler for a rotary kiln. The tube coolers are multiple and arranged in a planetary fashion around the kiln

U.S. Pat. No. 4,506,453 discloses a rotary drum with flights with enhanced heat transfer process for solids heating, cooling and drying, which is achieved by forced recirculation of the gas.

U.S. Pat. No. 4,742,622 discloses a rotary dryer design wherein the material lifted by vanes is dropped onto a co-axial structure for efficient drying.

U.S. Pat. No. 4,964,226 discloses a dryer with vanes mounted radially on a central longitudinal shaft in addition to the peripheral vanes. The arrangement is provided to assist in the sliding movement of the material over the vanes.

U.S. Pat. No. 5,083,382 discloses a rotary dryer with adjustable flights and dam.

U.S. Pat. No. 5,273,355 discloses an apparatus combining a rotary dryer and a rotary incinerator.

U.S. Pat. No. 5,203,693 discloses a rotary dryer with a dam and flight construction to shield the metal shell of the dryer from the radiant heat of the flame.

U.S. Pat. No. 5,740,617 discloses a dryer design to obtain discrete solid particles from slurry. The design incorporates an outer cylinder, another second perforated cylinder co-axial to the first and another third off-centered cylinder within the second cylinder.

U.S. Pat. No. 6,143,137 discloses another rotary cooler design with cooling pocket and a flexible vent pipe assembly capable of movement in response to the expansion or contraction of the cooling pocket.

U.S. Pat. No. 7,500,426 discloses a compartmentalized apparatus for food processing consisting of two compartments. Each compartment contains a rotatable mounted drum for the cooling medium.

In the aforementioned prior art, the volume of material discharged from the flight at a particular location during rotation and the manner in which the particles are dispersed across the cross-section of the drum considerably affects the heat and mass transfer process. This is because heat and mass transfer is directly proportional to the amount of surface area available. The spatial distribution of particles has a significant effect on the available surface area. Conventionally, upon release from the flights, the particle mass form clusters. As the particles begin to fall, they become airborne. As the particles progressively fall towards the bottom, they gradually spread out. One of the disadvantages of the prior art is that during fall of the particles, the dispersion of the particles attains a maximum value which then remains constant. This leads to limiting the heat and mass transfer. Further, another disadvantage of the prior art is that the arrangement of the flights/lifters and drum assembly is complex.

Hence, there was felt a need for increasing the spread of the particles as well as the heat and mass transfer.

### OBJECT OF THE INVENTION

One object of the present invention is to increase the rate of heat transfer.

Another object of the present invention is to increase the mass transfer.

Still another object of the present invention is to increase the output of rotary drums.

Yet another object of the present invention is to reduce the time required for heat and mass transfer.

Further an object of this invention is to simplify the technique and expand its easy implementation.

### SUMMARY OF THE INVENTION

In accordance with the present invention there is provided dispersion apparatus for dispersing a particulate mass resident in a drum, the drum adapted to be rotated about an operatively longitudinal axis, the dispersion apparatus comprising a plurality of perforated flights.

Typically, the perforated flights are made by casting, forging, drawing, stamping, welding and/or bending of sheet materials.

Preferably, the perforated flights are of a predetermined profile, the predetermined profile being non-linear and forming at least one angular edge between at least two flat portions.

Alternatively, the perforated flights are provided as single protrusions at an angle to the inner wall of the drum.

Typically, the perforated flights are provided with a plurality of perforations selected from the group consisting of slits, slots, holes, elliptical apertures, oblong apertures, oval apertures and a combination thereof.

Typically, the perforations are planar perforations and non-planar perforations.

Typically, at least one of the non-planar perforations is located along the angular edge and the planar perforations being located on the flat portion.

Typically, the perforated flights are adapted to radially extend from the inner surface of the rotating drum.

Typically, the perforations are formed on the surface of the perforated flights, within depressions, dimples or projections formed on the perforated flights.

Typically, the flights include non-perforated structures comprising depressions, dimples or projections.

Typically, the perforations are provided with an entry end and an exit end for entry and exit of the particulate mass respectively, the perforations being adapted to taper such that the cross-sectional area of the perforations at the exit end is larger than the cross-sectional area of the perforations at the entry end.

Alternatively, the perforations are provided with an entry end and an exit end for entry and exit of the particulate mass respectively, the perforations are provided with a larger cross-sectional area at the entry end and a smaller cross-sectional area at the exit end.

Alternatively, the perforations are provided with an entry end and an exit end for entry and exit of the particulate mass respectively, the perforations are provided with equal cross-sectional areas at the entry end and the exit end.

Typically, the size and the number of the perforations are dependent on the capacity of the rotary drum, the heat duty of the rotary drum, the particle size distribution and the nature of the particles.

Typically, the perforated flights are mounted on the drum by at least one method selected from the group of method comprising bonding, welding, riveting and bolting.

Typically, a plurality of ring of perforated flights are spaced apart with respect to each other, each ring consisting of a plurality of perforated flights, the perforated flights radially extending into the inner space of the drum.

Typically, the perforated flights in one of the rings are staggeredly non-aligned with respect to a corresponding perforated flight on an adjacent ring.

Alternatively, the perforated flights in one of the rings are staggeredly aligned with respect to a corresponding perforated flight on an adjacent ring.

### BRIEF DESCRIPTION OF THE FIGURES

Other aspects of the invention will become apparent by consideration of the accompanying drawing and their description stated below, which is merely illustrative of a preferred embodiment of the invention and does not limit in any way the nature and scope of the invention.

FIG. 1 illustrates the perforated flight in accordance with the present invention;

FIG. 2 illustrates the cross sectional view of the rotary drum fitted with a plurality of perforated flights illustrated in FIG. 1;

FIG. 3 illustrates the sectional view along the longitudinal axis of the rotary drum;

FIG. 4 illustrates the test results for a conventional flight; and

FIG. 5 illustrates the test result for the perforated flight of the present invention.

### DETAILED DESCRIPTION OF THE INVENTION

The invention will now be described with reference to the accompanying drawings which do not limit the scope and ambit of the invention. The description provided is purely by way of example and illustration.

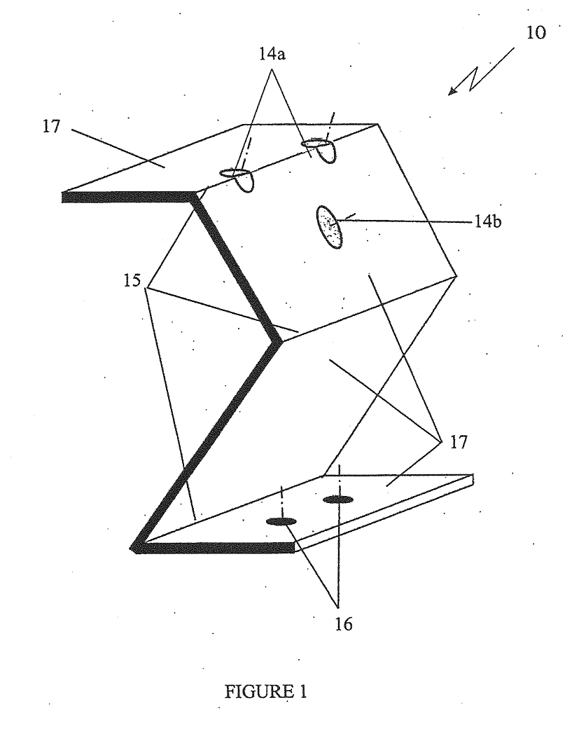

Referring to the accompanied drawings, a dispersion apparatus, in accordance with this invention is generally indicated by the reference numeral 10 and is particularly shown in FIG. 1 of the drawings.

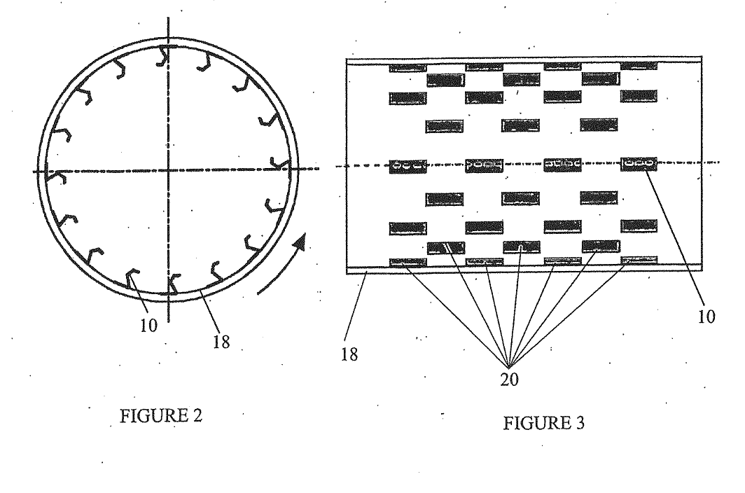

The dispersion apparatus comprises a plurality of perforated flights (10) fitted to the inner circumference of a drum (18), shown in FIG. 2 and FIG. 3. The dispersion apparatus enables in dispersing a particulate mass contained in the drum (18) which is rotated about an operatively longitudinal axis. The drum (18) is provided with an inclination in the range of zero degrees to ten degrees to the longitudinal axis of the drum (18). The perforated flights (10) are made of sheet material and are made by the processes of casting, forging, drawing, stamping, welding and/or bending of sheet materials. The perforated flights (10) are mounted on the drum (18) by at least one method selected from the group of methods comprising gluing, magnetic bonding, welding, riveting and bolting. The bolting and riveting of the perforated flights (10) to the drum (18) is carried out through fixing holes (16). Alternatively, the perforated flights (10) are mounted on a separate housing/casing within the drum (18) such that the drum (18) and the housing/casing with the perforated flights (10) mounted thereon are rotated at the same/different speeds, in the same or in different directions. The cross-section of the drum (18) is selected from the group comprising circle, square, rectangle, regular polygon, irregular polygons. Again, the cross-sectional area along the length of the drum (18) is varying or is maintained constant.

The perforated flights (10) are provided with a predetermined profile which is linear or non-linear. The perforated flights (10) having a linear profile are provided as single protrusions extending at an angle to the inner wall of the drum (18). The perforated flights (10) having a non-linear profile are formed by at least one angular edge (15). Each of the angular edge (15) is formed between two flat portions (17). At least one of the flat portions (17) located between two angular edges (15). Each of the perforated flight (10) is provided with at least one non-planar perforation (14a) and at least one planar perforation (14b), as shown in FIG. 1. The non-planar perforation (14a) is located along the angular edge (15) while the planar perforation (14b) is located at a predetermined distance on the flat portions (17) located between the two angular edges (15). The non-planar perforation (14a) and the planar perforation (14b) enables in better dispersion of the particulate mass contained in the drum (18). The non-planar perforations (14a) and the planar perforation (14b) are provided with an entry end and an exit end for entry and exit of the particulate mass respectively. The non-planar perforations (14a) and the planar perforation (14b) are made to taper such that the cross-sectional area of the non-planar perforations (14a) and the planar perforation (14b) at the exit end is larger than the cross-sectional area of the non-planar perforations (14a) and the planar perforation (14b) at the entry end. The taper provided to the non-planar perforations (14a) and the planar perforation (14b) either provided with uniform taper angle or non uniform taper angle. Alternatively, the perforations (14a and 14b) are provided with equal cross-sectional areas at said entry end and said exit end or are provided with a larger cross-sectional area at said entry end and a smaller cross-sectional area at said exit end.

The non-planar perforations (14a) and the planar perforation (14b) are selected from the group consisting of slits, slots, holes, elliptical apertures, oblong apertures, oval apertures and a combination thereof. The non-planar perforations (14a) and the planar perforation (14b) are formed on the surface of the perforated flights (10) or are formed within depressions, dimples or projections formed on the perforated flights (10). Additionally, the perforated flights (10) include non-perforated structures comprising depressions, dimples or projections. The size and the number of the non-planar perforations (14a) and the planar perforation (14b) are dependent on the capacity of the drum (18), the heat duty of the drum (18), the particle size distribution and the nature of the particulate mass.

The perforated flights (10) radially extend from the inner circumference of the drum (18) towards the inner space of the drum (18), as shown in FIG. 2. A plurality of perforated flights (10) is arranged along the inner circumference of the drum (18) so as to form a ring of flights (20). A plurality of rings of flights (20) is provided along the length of the drum (18). Each of the rings of flights (20) is spaced apart with respect to each other by a predetermined distance. The flights (10) in each of the ring of flights (20) are angularly offset from the flights (10) of the adjacent ring of flights (20). The flights (10) in one of the ring of flights (20) are staggeredly aligned or non-aligned with respect to a corresponding flight (10) on an adjacent ring of flight (20).

### TESTS CONDUCTED

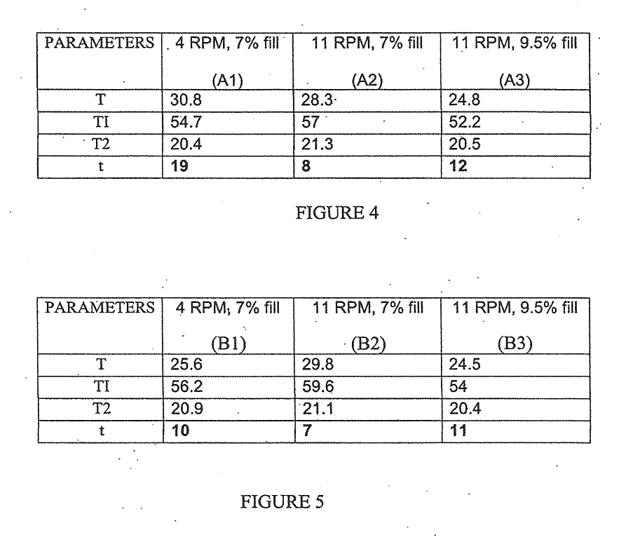

FIG. 4 illustrates the test data for rotary drum using conventional flights while FIG. 5 illustrates the test data for a rotary drum using perforated flights of the present invention. The ambient temperature (T) at the time of the test, the temperature of the particulate mass during the operation of the drum (T1) at a certain time instant and the quantum of reduction in the temperature of the particulate mass (T2) from the temperature T1 after further operation of the drum for the cooling time (t) were recorded. The tests were conducted for different amounts of particulate mass and different speeds of rotation of the drum, namely, A1, A2 and A3 for the conventional flights and B1, B2 and B3 for the perforated flights of the present invention. The cooling time (t) required for cooling the particulate mass from the temperature T 1 by a drop of temperature T2 is 8% to 47% less in case of the drum fitted with the perforated flights of the present invention in comparison to the conventional flights.

### TECHNICAL ADVANTAGES

The product as described herein above offers several advancements over similar products disclosed in the prior art. The dispersion apparatus in accordance with the present invention with the perforated flights help in improving the specific energy utilization. Further, the use of the perforated flights helps in increasing the throughput of the rotary drum units. The perforated flights helps in reducing the time required for heat and mass transfer by increasing the contact surface of the particulate mass to be dispersed with the surrounding gas by the dispersion apparatus. The present invention is simple to implement and can be easily incorporated in conventional flights in a very cost effective manner.

Wherever a range of values is specified, a value up to 10% below and above the lowest and highest numerical value respectively, of the specified range, is included in the scope of the invention.

In view of the wide variety of embodiments to which the principles of the present invention can be applied, it should be understood that the illustrated embodiments are exemplary only. The numerical values given of various physical parameters and dimensions are only approximations and it is envisaged that the values higher or lower than the numerical values assigned to the parameters, dimensions and quantities fall within the scope of the invention.

While considerable emphasis has been placed herein on the components and component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

1. A dispersion apparatus for dispersing a particulate mass resident in a drum, said drum being rotatable about an operatively longitudinal axis, said dispersion apparatus comprising a plurality of perforated flights.

2. The dispersion apparatus according to claim 1, wherein said plurality of perforated flights are made by at least one method selected from the group consisting of casting, forging, drawing, stamping, welding and bending of sheet materials.

3. The dispersion apparatus according to claim 1, wherein said plurality of perforated flights comprise a predetermined profile, said predetermined profile being non-linear and forming at least one angular edge between at least two flat portions.

4. The dispersion apparatus according to claim 1, wherein said plurality of perforated flights are provided as single protrusions at an angle to the inner wall of the drum.

5. The dispersion apparatus according to claim 1, wherein said plurality of perforated flights are provided with a plurality of perforations selected from the group consisting of slits, slots, holes, elliptical apertures, oblong apertures, oval apertures and a combination thereof.

6. The dispersion apparatus according to claim 4, wherein said plurality of perforations are selected from the group consisting of planar perforations and non-planar perforations.

7. The dispersion apparatus according to claim 5, wherein at least one of said non-planar perforations are located along said angular edge and said planar perforations are located on said flat portion.

8. The dispersion apparatus according to claim 1, wherein said plurality of perforated flights radially extend from the inner surface of the rotating drum.

9. The dispersion apparatus according to claim 1, wherein said plurality of perforations are formed on the surface of said plurality of perforated flights, within an area selected from the group consisting of depressions, dimples and projections formed on said plurality of perforated flights.

10. The dispersion apparatus according to claim 1, wherein said plurality of perforated flights include non-perforated structures comprising an area selected from the group consisting of depressions, dimples and projections.

11. The dispersion apparatus according to claim 1, wherein said plurality of perforations comprise an entry end and an exit end for entry and exit of the particulate mass respectively, wherein said plurality of perforations taper such that the cross-sectional area of the plurality of perforations at the exit end is larger than the cross-sectional area of the plurality of perforations at the entry end.

12. The dispersion apparatus according to claim 1, wherein said plurality of perforations comprise an entry end and an exit end for entry and exit of the particulate mass respectively, wherein said plurality of perforations comprise a larger cross-sectional area at said entry end and a smaller cross-sectional area at said exit end.

13. The dispersion apparatus according to claim 1, wherein said plurality of perforations comprise an entry end and an exit end for entry and exit of the particulate mass respectively, wherein said plurality of perforations comprise equal cross-sectional areas at said entry end and said exit end.

14. The dispersion apparatus according to claim 1, wherein the size and the number of said plurality of perforations are dependent on the capacity of the rotary drum, the heat duty of the rotary drum, the particle size distribution and the nature of the particles.

15. The dispersion apparatus according to claim 1, wherein said plurality of perforated flights are mounted on said rotary drum by at least one method selected from the group of methods consisting of bonding, welding, riveting and bolting.

16. The dispersion apparatus according to claim 1, wherein a plurality of ring of perforated flights are spaced apart with respect to each other, each ring consisting of a plurality of perforated flights, said perforated flights radially extending into the inner space of the drum.

17. The dispersion apparatus according to claim 16, wherein said plurality of perforated flights in one of said rings are staggeredly non-aligned with respect to a corresponding perforated flight on an adjacent ring.

18. The dispersion apparatus according to claim 16, wherein said plurality of perforated flights in one of said rings are staggeredly aligned with respect to a corresponding perforated flight on an adjacent ring.

19. The dispersion apparatus according to claim 1, wherein said rotary drum comprises an inclination in the range of zero degrees to ten degrees to the longitudinal axis of said rotary drum.
